(19) United States
(12) Patent Application Publication
(10) Pub. No.: US 2011/0242658 A1
(43) Pub. Date: Oct. 6, 2011

(54) FILM STRUCTURE HAVING INORGANIC SURFACE STRUCTURES AND RELATED FABRICATION METHODS

(75) Inventor: Kalluri R. Sarma, Mesa, AZ (US)

(73) Assignee: Honeywell International Inc., Morristown, NJ (US)

(21) Appl. No.: 12/753,964

(22) Filed: Apr. 5, 2010

(51) Int. Cl. G02B 5/00; B05D 5/06; B29D 11/00; B32B 3/10

(52) U.S. Cl. 359/507; 427/162; 216/24; 428/195.1; 428/210

(57) ABSTRACT

Methods and apparatus are provided for forming a smudge-resistant film structure that comprises a plurality of transparent inorganic surface structures overlying a transparent substrate. A method for forming the film structure comprises providing a transparent substrate and forming a plurality of transparent surface structures overlying the transparent substrate, wherein each of the transparent surface structures comprises an inorganic material.

### TECHNICAL FIELD

The subject matter described herein relates generally to electronic display systems, and more particularly, embodiments of the subject matter relate to transparent film structures for use with touch-sensing devices in electronic display systems.

### BACKGROUND

Traditionally, electronic displays interfaced with a user via mechanical controls, such as knobs, buttons, or sliders, in order to enable a user to control or adjust various system properties. Touchscreen technology enables many system designers to reduce the space requirements for an electronic display system by integrating or incorporating the mechanical control functionality into the display. Accordingly, electronic equivalents of the traditional mechanical controls have been developed to allow a user to adjust system properties via a touchscreen interface.

Repetitive use of the touchscreen interface may result in fingerprints, smudges, scratches, and/or other marks on the surface of a touchscreen display. These markings degrade the clarity of the display, which in turn, increases the difficulty of reading or otherwise comprehending the content displayed on the display. For example, fingerprints and/or smudges may increase the surface reflection, cause the display to appear hazy or blurred, or otherwise undesirably impair the image quality perceived by a user. These problems are exacerbated in high ambient lighting conditions, such as, for example, in the cockpit of an aircraft during flight. Accordingly, it is desirable to provide a display surface that is resistant to fingerprints, smudges, scratches, and/or other marks without degrading the display image quality by increasing surface reflection.

One proposed approach involves using polymer processing techniques, such as molding, curing by actinic radiation, embossing, or the like, to provide a microstructured polymer film that may be applied to the touchscreen to prevent formation of surface marks. However, polymer films may not provide sufficient surface hardness and durability for use in some military, avionics, and/or industrial applications that have stringent design constraints. Additionally, some polymer films may not be compatible with other surface treatments, such as anti-reflective coatings which are used to reduce surface reflection or low surface energy coatings which are used to improve cleanability.

### BRIEF SUMMARY

Methods are provided for forming a film structure. An exemplary method comprises providing a transparent substrate and forming a plurality of transparent surface structures overlying the transparent substrate. Each of the transparent surface structures comprises an inorganic material.

In another embodiment, an apparatus is provided for a film structure. The film structure comprises a transparent substrate and a plurality of transparent surface structures overlying the transparent substrate. Each transparent surface structure of the plurality of transparent surface structures comprises an inorganic material formed overlying the transparent substrate.

### BRIEF DESCRIPTION OF THE DRAWINGS

Embodiments of the subject matter will hereinafter be described in conjunction with the following drawing figures, wherein like numerals denote like elements, and

FIGS. 1-4 are cross-sectional views that illustrate a film structure and exemplary methods for fabricating the film structure in accordance with one embodiment;

FIGS. 5-7 are cross-sectional views that illustrate a film structure and exemplary methods for fabricating the film structure in accordance with another embodiment;

FIGS. 8-9 are cross-sectional views that illustrate a film structure and exemplary methods for fabricating the film structure in an exemplary embodiment;

FIG. 10 is a cross-sectional view that illustrates an exemplary embodiment of a display system that includes a film structure formed in accordance with the fabrication process of either FIGS. 1-4 or FIGS. 5-7 affixed to a display surface of a display device;

FIG. 11 is a cross-sectional view that illustrates another exemplary embodiment of a display system that includes a film structure formed in accordance with the fabrication process of either FIGS. 1-4 or FIGS. 5-7; and

FIG. 12 is a top view of an exemplary embodiment of a film structure formed in accordance with the fabrication process of either FIGS. 1-4 or FIGS. 5-7.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies described herein may be utilized to fabricate a transparent film structure suitable for use with display devices, touchscreens, touch panels, or other devices that it is desirable protect from fingerprints, smudges, scratches, and/or other surface markings. A transparent film structure includes a plurality of surface structures formed from a transparent inorganic material overlying a transparent substrate. The surface structures are arranged to provide a pattern comprising any number of shaped-features that are configured to break up, redistribute, or otherwise inhibit formation of a continuous region of a contaminant on the surface of the transparent substrate. The inorganic material has a pencil hardness greater than about six (e.g., 6H) and provides a scratch resistant, durable surface. The transparent film structure may be affixed to the surface of a display, touchscreen, touch panel, or another display device to provide a display surface having relatively low surface reflection and relatively high durability.

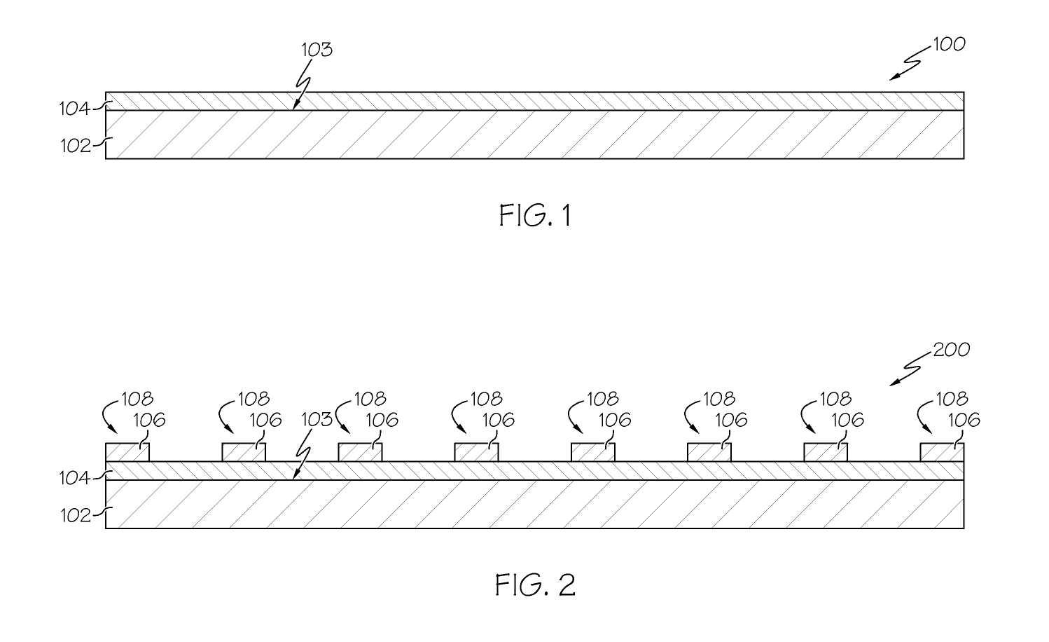

Referring now to FIG. 1, in an exemplary embodiment, the illustrated fabrication process begins by providing a substrate 102 and forming a layer of an inorganic material 104 overlying the substrate 102, resulting in film structure 100. As used herein, an inorganic material should be understood as a non-polymeric chemical compound that does not include carbon. In this regard, the inorganic material 104 is physically harder and exhibits greater durability with respect to mechanical abrasion as compared to polymeric materials. The substrate 102 provides structural support for surface structures subsequently formed from the inorganic material 104, as described in greater detail below. In an exemplary embodiment, the substrate 102 has a transparency (or transmittance) greater than about ninety-five percent for visible light, and the inorganic material 104 has a transparency (or transmittance) greater than about ninety percent for visible light. In this regard, the substrate 102 and the inorganic material 104 are each substantially transparent. Accordingly, for convenience, the substrate 102 may alternatively be referred to herein as a transparent substrate, and the inorganic material 104 may alternatively be referred to herein as a transparent inorganic material.

In an exemplary embodiment, the transparent substrate 102 comprises a material having a refractive index less than about 2.0, and preferably within the range of about 1.4 to about 1.7. Depending on the embodiment, the transparent substrate 102 may be realized as a glass material, such as soda-lime glass, or a polymer material, such as polyethylene terephthalate (PET), polyethylene naphthalate (PEN), polycarbonate (PC), or the like. It will be appreciated that when the transparent substrate 102 is realized as a glass material, the transparent substrate 102 provides a relatively rigid structural support for the subsequently formed surface structures whereas the transparent substrate 102 provides a relatively flexible and/or malleable structural support when realized as a polymer material. In an exemplary embodiment, the transparent substrate 102 provides a substantially planar surface 103 for subsequently forming surface structures thereon.

In an exemplary embodiment, the thickness and type of material utilized as substrate 102 are chosen such that the substrate 102 does not interfere with touch-sensing capabilities of a touchscreen, touch panel, or another touch-sensing device that the film structure may be subsequently affixed to. For example, for resistive or capacitive touch-sensing technologies, it may be desirable that a thinner substrate 102 be used, whereas infrared or optical touch-sensing technologies may tolerate a thicker substrate 102. Additionally, it may be desirable that the film structure 100 have more rigidity for some applications or more flexibility for other applications. In this regard, in practice, the particular material utilized as substrate 102 and the thickness of the transparent substrate 102 will vary depending on the needs of the particular application. For example, in embodiments where a rigid glass material is used as transparent substrate 102, the glass material may have a thickness of about two millimeters or less when used with infrared or other optical touch sensing technologies and a thickness within the range from about 50 microns (or micrometers) to about 100 microns when used with resistive or capacitive touch sensing technologies. In alternative embodiments where a flexible polymer material is used as transparent substrate 102, the polymer material may have a thickness within the range of about 0.1 millimeters to about 0.3 millimeters.

As set forth above, in an exemplary embodiment, the inorganic material 104 has a pencil hardness greater than about six (6H). In one or more embodiments, the inorganic material 104 has a hardness greater than steel wool, such that the inorganic material 104 resists scratching and/or surface marking that would otherwise result from abrading the surface of the inorganic material 104 with steel wool. In this regard, the inorganic material 104 is durable and resistant to scratching or other forms of structural damage that may be caused by touching the surface of the inorganic material 104 with a finger and/or fingernail, a stylus, a pen, or another object that may be used to interface with a touch-sensing device (e.g., display, touchscreen, touch panel, or the like) that the transparent film structure may be subsequently affixed to. In an exemplary embodiment, the inorganic material 104 is also resistant to fluids and solvents commonly used to clean display surfaces. For example, some industrial solvents that may damage polymer materials may come in contact with the inorganic material 104, without damaging it.

In an exemplary embodiment, the inorganic material 104 is realized as a silicon oxide, preferably silicon dioxide. It should be noted that other materials having the same general properties and characteristics could be used as the inorganic material in lieu of silicon dioxide, such as, for example, silicon nitride, silicon oxynitride, aluminum oxide, and the like. That said, silicon dioxide is commonly used for other purposes, is accepted for use in the industry, and is well documented. Accordingly, preferred embodiments employ silicon dioxide for the inorganic material 104, and for ease of description, but without limitation, the inorganic material 104 may alternatively be referred to herein as silicon dioxide.

In an exemplary embodiment, the layer of inorganic material 104 is formed by depositing the inorganic material 104 overlying the transparent substrate 102 to a thickness within the range of about 4 microns to about 50 microns using a plasma enhanced chemical vapor deposition (PECVD) process or another suitable deposition process (e.g., physical vapor deposition using vacuum sputtering). As shown in FIG. 1, in accordance with one embodiment, the layer of inorganic material 104 is conformably deposited on the planar surface 103 of the transparent substrate 102 such that the layer of inorganic material 104 is in contact with the planar surface 103 of the substrate 102 and has a substantially uniform thickness across the planar surface 103 of the substrate 102. As described in greater detail below, the thickness of the layer of inorganic material 104 defines the height of surface structures subsequently formed from the inorganic material 104.

In accordance with one embodiment, a layer of silicon dioxide 104 is formed by PECVD using silane and nitrous oxide as reactants. In an exemplary embodiment, the ratio of silane to nitrous oxide and other PECVD process conditions, such as the chamber pressure and/or radio frequency power density, are controlled such that the silicon dioxide 104 has a transparency (or transmittance) greater than about ninety-five percent for visible light, a pencil hardness within the range of about six (6H) to about nine (9H), and a refractive index that is substantially equal to the refractive index of the transparent substrate 102. For example, in accordance with one embodiment, the substrate 102 is realized as soda-lime glass having a refractive index of about 1.5, wherein the ratio of silane to nitrous oxide is chosen such that the silicon dioxide 104 has a refractive index of about 1.5. In an exemplary embodiment, the refractive index of the silicon dioxide 104 is substantially equal to the refractive index of the substrate 102 to minimize surface reflection

After depositing the inorganic material 104, to densify the layer of inorganic material 104 and achieve a desired refractive index and/or hardness, the film structure 100 may be annealed, for example, by rapid thermal annealing or another suitable annealing process. When glass material is used for the transparent substrate 102, the temperatures of the deposition process and the annealing process are each chosen to be less than the maximum process temperature capability of the glass material (e.g., less than the glass transition temperature). In this regard, in accordance with one embodiment, when the transparent substrate 102 comprises a glass material, the temperatures of the deposition process and the temperature of the annealing process are each less than about 400° C. Alternatively, when a polymer material is used for the transparent substrate 102, the temperatures of the deposition process and the annealing process are each chosen to be less than the maximum process temperature capability of the polymer material (e.g., less than the softening point for the polymer material). In this regard, when the transparent substrate 102 comprises a polymer material, the temperature of the deposition process and the temperature of the annealing process are each less than about 200° C., depending on the particular polymer material being utilized as the transparent substrate 102.

Referring now to FIG. 2, in an exemplary embodiment, the fabrication process continues by forming a layer of masking material 106 overlying the film structure 100 and selectively removing portions of the masking material 106 to create and define a mask 108 overlying the inorganic material 104, resulting in film structure 200. As described in greater detail below, the mask 108 defines pattern for the surface structures (e.g., the shapes and/or dimensions of surface structures and the spacing between adjacent surface structures) that are subsequently formed from portions of the underlying inorganic material 104. In an exemplary embodiment, the masking material 106 is realized as a photoresist material, wherein the mask 108 is formed by applying the photoresist material 106 and patterning and removing portions of the photoresist material 106 using conventional photolithography, resulting in the mask 108.

Referring now to FIGS. 3-4, in an exemplary embodiment, the fabrication process continues by selectively removing portions of the inorganic material 104 using the mask 108 to form a plurality of surface structures 110 overlying the substrate 102. In an exemplary embodiment, the exposed portions of the inorganic material 104 are removed using an anisotropic (or directional) etch process, resulting in film structure 300. For example, exposed portions of silicon dioxide 104 may be anisotropically etched by plasma-based reactive ion etching (RIE) using an anisotropic etchant chemistry, such as carbon tetrafluoride/oxygen (CF₄/O₂) plasma chemistry or a sulfur hexafluoride (SF₆) plasma chemistry. The mask 108 prevents the anisotropic etching process from removing portions of the inorganic material 104 underlying the mask 108 while the exposed portions of the inorganic material 104 (i.e., the portions that do not underlie mask 108) are removed. In this regard, photoresist material 106 is preferably resistant to the anisotropic etchant chemistry and/or has a thickness such that the upper surfaces of the underlying anti-smudge surface structures 110 are not exposed during the etch process. In an exemplary embodiment, the inorganic material 104 is etched using the mask 108 until regions of the planar surface 103 of the substrate 102 between surface structures 110 are exposed. After removing exposed portions of the inorganic material 104, in an exemplary embodiment, the fabrication process continues by removing the mask 108, resulting in the film structure 400 of FIG. 4. For example, the photoresist material 106 may be removed (or stripped) by a photoresist removal process using commonly known solvent chemistries, such as acetone, that removes the photoresist material 106 and leaves the inorganic material 104 and substrate 102 substantially intact.

As shown, after etching the silicon dioxide 104 and removing the photoresist material 106, the film structure 400 comprises a plurality of surface structures 110 on the surface 103 of the transparent substrate 102. In an exemplary embodiment, the surface structures 110 are arranged to provide a pattern comprising any number of shaped-features across the surface of the substrate 102 that are configured to break up, redistribute, or otherwise inhibit formation of a continuous region of a contaminant (e.g., oils, sweat, and the like resulting from finger prints, dust, or other environmental contaminants) on the surface 103 of the film structure 400. In this regard, the surface structures 110 may alternatively be referred to herein as anti-smudge or anti-fingerprint surface structures. The height 112, width 114 and/or separation distance 116 between adjacent structures 110 are preferably chosen to achieve a desired level of anti-smudge and anti-finger print performance by preventing a substantial portion of the surface 103 from being touched by fingertips of a user under practical finger touching pressure conditions. As described above, the height 112 of the surface structures 110 relative to the surface 103 of the substrate 102 corresponds to the thickness of the layer of inorganic material 104. In this regard, depending on the embodiment, the anti-smudge surface structures 110 may have a height 112 relative to the surface of the substrate 102 ranging from about 4 microns to about 50 microns. In an exemplary embodiment, the cross-sectional width 114 of the surface structures 110 may range from about 5 microns to about 30 microns. However, it should be appreciated that the particular height, width and spacing of the surface structures 110 will depend on the particular shapes and/or patterns that are desired for a particular application, and practical embodiments may employ surface structures having larger and/or smaller heights and/or cross-sectional widths. Furthermore, although FIG. 4 depicts the anti-smudge surface structures 110 as being isolated or otherwise separated, in practice, the anti-smudge surface structures 110 may be integrally formed and/or interconnected to provide various shapes and/or patterns overlying the surface of the substrate 102. Thus, the particular shapes and/or patterns formed by the anti-smudge surface structures 110 will vary depending on the embodiment. Additionally, in an exemplary embodiment, the anti-smudge surface structures 110 are arranged and/or spaced in a manner that prevent creation of Moiré patterns when the film structure 400 is subsequently utilized with a display having a periodic pixel structure and/or other periodic pattern on the display. In this regard, the cross-sectional widths 114 and/or separation distances 116 between adjacent surface structures 110 may be non-periodic or non-uniform across the surface 103 of the substrate 102. Accordingly, the subject matter is not intended to be limited to any particular geometric shape, arrangement and/or pattern of the surface structures 110 on the surface 103 of the substrate 102.

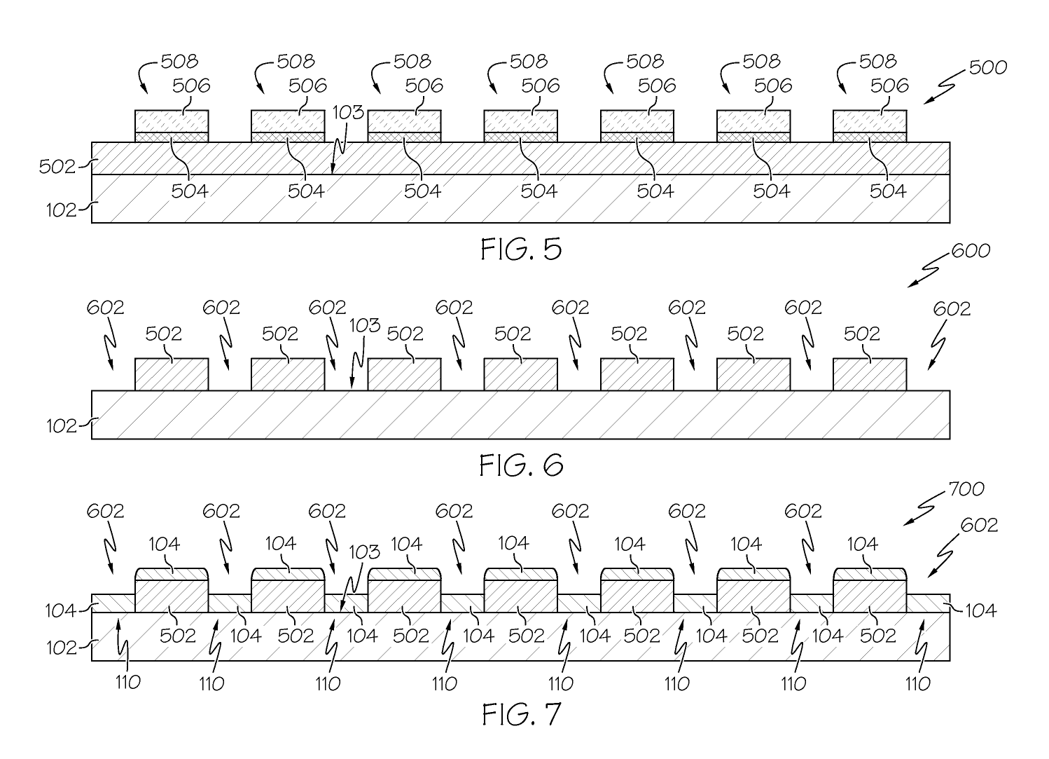

By virtue of the anisotropic etching process described above, the anti-smudge surface structures 110 have sidewalls 118 that are substantially vertical (e.g., orthogonal to the planar surface 103 of the substrate 102) neglecting any rounding at the corners of the surface structures 110. Additionally, by virtue of the inorganic material 104 being conformably deposited across the planar surface 103 of the substrate 102, the surface structures 110 have substantially uniform height across the film structure 400 and each surface structure 110 has an upper surface 119 that is substantially horizontal (e.g., parallel to the planar surface 103 of the substrate 102) neglecting any rounding at the corners of the surface structures 110. The vertical sidewalls 118 reduce diffusion and/or scattering of light incident on the film structure 400 orthogonal to the planar surface 103 while the horizontal upper surfaces 119 reduce variations in the amount of diffusion and/or scattering among the surface structures 110 across the substrate 102, thereby maintaining the clarity and/or effective resolution perceived by a user viewing a display device having the film structure 400 affixed to its display surface. After removing the photoresist material 106, the fabrication of the film structure may be completed and the film structure affixed to a display device as described in greater detail below in the context of FIGS. 8-11.

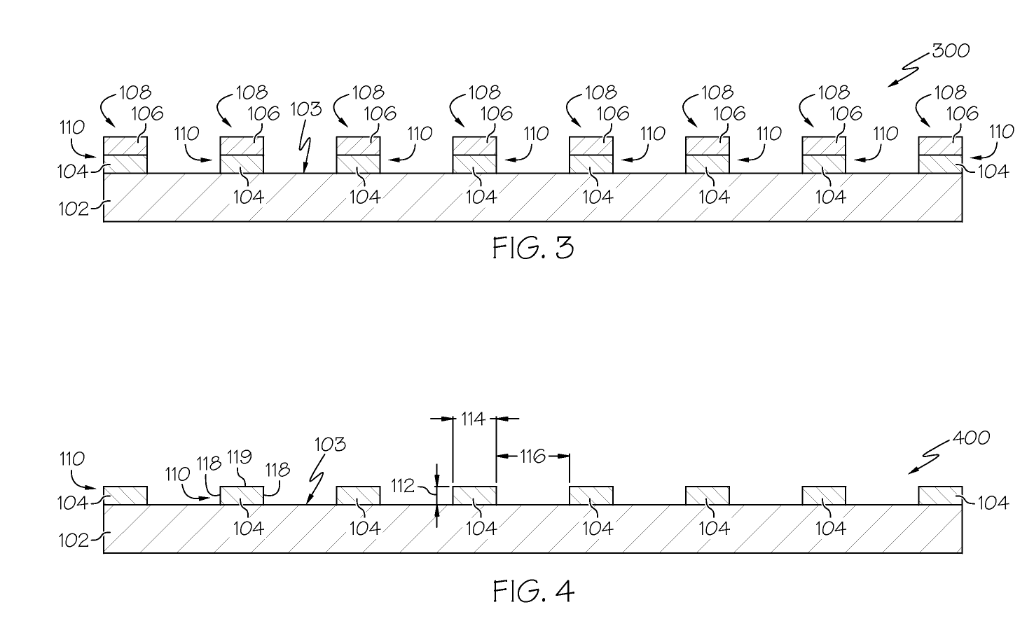

FIGS. 5-7 illustrate an alternate embodiment of the fabrication process described above. In this regard, the steps described here in the context of FIG. 5-7 may be utilized to form the film structure 400 of FIG. 4. The illustrated fabrication process begins by forming a layer of photoresist material 502 overlying the substrate 102. In an exemplary embodiment, a mask layer 504 is formed overlying the layer of photoresist material 502, and a second layer of photoresist material 506 is formed overlying the mask layer 504. The upper layer of photoresist material 506 is patterned and portions of the photoresist material 506 are removed using conventional photolithography. The remaining portions of the photoresist material 506 are used as an etch mask to selectively remove exposed portions of the mask layer 504 to create mask 508 by etching the mask layer 504 using a wet etchant, resulting in the film structure 500 of FIG. 5. The mask 508 defines a pattern for subsequently formed anti-smudge surface structures, as described in greater detail below.

Referring now to FIG. 6 and with continued reference to FIG. 5, after forming mask 508, the illustrated embodiment of the fabrication process continues by selectively removing portions of the photoresist material 502 using the mask 508 as an etch mask. In an exemplary embodiment, the exposed portions of the photoresist material 502 are removed using an anisotropic etch process, resulting in film structure 600. For example, the exposed portions of the photoresist material 502 may be anisotropically etched by plasma-based reactive ion etching (RIE) using a carbon tetrafluoride/oxygen (CHF₄/O₂) plasma chemistry, a sulfur hexafluoride (SF₆) plasma chemistry, or another suitable chemistry. The mask 508 prevents or otherwise protects the anisotropic etchant from removing portions of the photoresist material 502 underlying the mask 508 while the exposed portions of the photoresist material 502 (i.e., the portions that do not underlie mask 508) are removed. In an exemplary embodiment, the photoresist material 502 is etched until the upper surface 103 of the substrate 102 is exposed. Because the entire film structure 500 is exposed to the reactive ion etching (RIE) environment, the anisotropic etch will also result in simultaneous removal of exposed portions of the photoresist material 506. As shown in FIG. 6, the anisotropic etch results in a patterned layer of photoresist material 502 having a plurality of voided regions 602 that expose a plurality of regions of the planar surface 103 of the substrate. In this regard, the voided regions 602 define the cross-sectional widths and/or shapes of the surface structures subsequently formed on the surface 103 of the substrate 102.

Referring now to FIG. 7, in an exemplary embodiment, the fabrication process continues by forming the layer of inorganic material 104 overlying the film structure 600, resulting in film structure 700. In an exemplary embodiment, the layer of inorganic material 104 is formed by depositing the inorganic material 104 overlying the patterned layer of photoresist material 502 and the transparent substrate 102 using a plasma enhanced chemical vapor deposition (PECVD) process or another suitable deposition process (e.g., vacuum deposition or sputter deposition), in a similar manner as described in the context of FIG. 1. However, the temperature of the deposition process is less than the softening point for the photoresist material 502. In this regard, in accordance with one embodiment, the temperature of the deposition process is less than about 200° C. In an exemplary embodiment, the layer of inorganic material 104 is deposited under mass-transport controlled conditions such that inorganic material 104 is not deposited on the entirety of the vertical surfaces (or sidewalls) of the photoresist material 502.

Referring again to FIG. 5 and with reference to FIG. 7, in an exemplary embodiment, the photoresist material 502 applied to the surface of the substrate 102 has a thickness that is greater than the thickness of the layer of inorganic material 104 (e.g., a thickness greater than the desired height for the subsequently formed surface structures). In an exemplary embodiment, the thickness of the layer of photoresist material 502 is about five to ten microns thicker than the thickness of the layer of inorganic material 104. As a result, the deposition of the inorganic material 104 partially fills the voided regions 602 and results in discontinuities between the inorganic material 104 that is deposited on the surface 103 of the substrate 102 within the voided regions 602 and the inorganic material 104 that is deposited on the photoresist material 502.

Referring again to FIG. 4 and with reference to FIG. 7, in an exemplary embodiment, after forming the inorganic material 104 overlying film structure 700, the fabrication process continues by stripping the photoresist material 502 using wet chemical processing. The photoresist material 502 is dissolved in a solvent such as acetone, while leaving the inorganic material 104 of surface structures 110 intact. As a result of this step, any portions of the inorganic material 104 overlying the photoresist material 502 (along with any remaining mask layer 504 and/or photoresist material 506 not removed earlier) are removed with the photoresist material 502 while the surface structures 110 remain on the surface 103 of the substrate 102. After removing the photoresist material 502, the resulting film structure 700 may be annealed in a similar manner as described in the context of FIG. 4.

Referring now to FIG. 8, in an exemplary embodiment, the fabrication process continues by forming an anti-reflective coating layer 120 overlying the film structure 400, resulting in film structure 800. In an exemplary embodiment, the anti-reflective coating layer 120 comprises a high efficiency anti-reflective (HEA) coating applied to the surface of the film structure 400. In accordance with one embodiment, the anti-reflective coating layer 120 is formed by conformably depositing one or more layers of materials that are arranged or otherwise configured to reduce the surface reflection of the film structure 800. For example, in an exemplary embodiment, the anti-reflective coating layer 120 is realized as a multi-layer dielectric stack comprising alternating layers of materials having a relatively higher refractive index (e.g., titanium dioxide) and a material having a relatively lower refractive index (e.g., silicon dioxide) that are deposited by performing a sputtering deposition process, an electron beam deposition process, or an ion beam deposition process. In an exemplary embodiment, the thickness of the anti-reflective coating layer 120 is less than about one micron and results in a surface reflection for the film structure 800 that is less than about one percent.

Referring now to FIG. 9, in an exemplary embodiment, after forming the anti-reflective coating layer 120, the fabrication process continues by forming a low surface energy coating layer 122 overlying the film structure 800, resulting in film structure 900. In this regard, a low surface energy coating layer 122 comprises a thin film of material having a surface energy less than about 35 dynes per centimeter, such as, for example, a hydrophobic material or an oleophobic material. In accordance with one embodiment, the low surface energy coating layer 122 is formed by dipping, submerging, or otherwise exposing (e.g., spin coating, spray coating, or the like) the upper surface of the film structure 800 in a hydrophobic and/or oleophobic material, such as, perfluoropolyether (PFPE) or another fluoroether. In an exemplary embodiment, the thickness of the low surface energy coating layer 122 is about 50 to 200 nanometers.

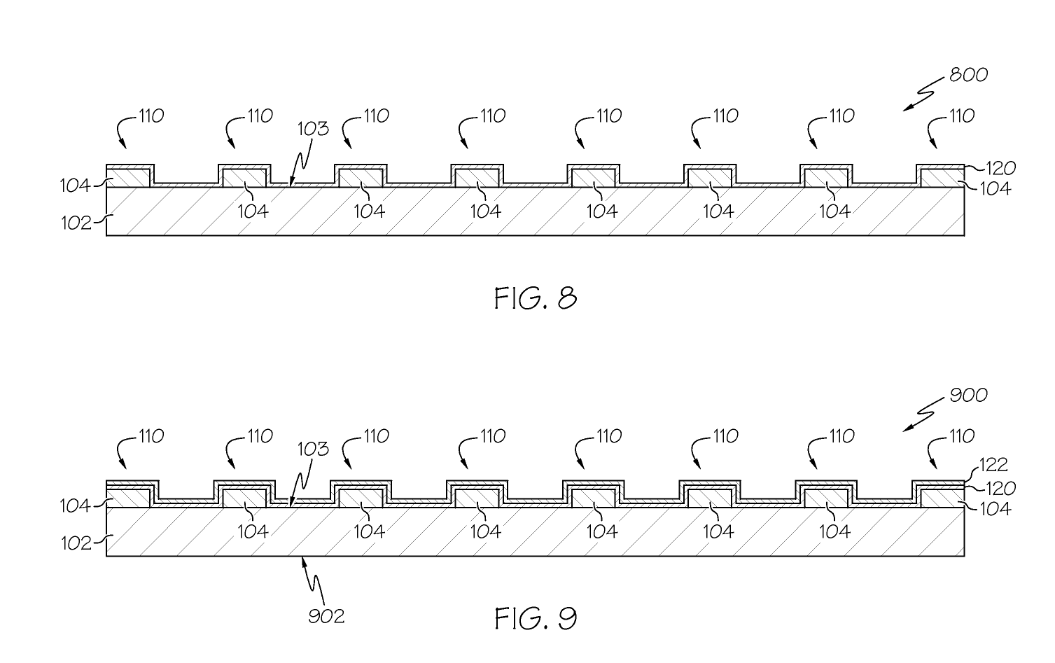

Referring now to FIG. 10, in an exemplary embodiment, the film structure 900 is utilized with a display device 1002 in a display system 1000. In accordance with one embodiment, the display system 1000 is utilized in the cockpit of an aircraft. The film structure 900 is disposed proximate the display device 1002 and aligned with respect to the display device 1002 such that the film structure 900 is interposed in the line-of-sight between a user and the display device 1002 when the user views content displayed on the display device 1002. In this regard, from the perspective of a user and/or viewer of the display device 1002, the film structure 900 overlaps and/or overlies at least a portion of the display device 1002.

In an exemplary embodiment, an adhesive material is formed on the surface 902 of the film structure 900 that is opposite planar surface 103, and the surface 902 of the film structure 900 is affixed to a display surface 1004 of the display device 1002. The adhesive material comprises a pressure sensitive adhesive having a refractive index that is substantially equal to the refractive index of the inorganic material 104. For example, in accordance with one embodiment, the inorganic material 104 comprises silicon dioxide having a refractive index of about 1.5 and the adhesive material comprises a pressure sensitive adhesive having a refractive index within the range of about 1.5 to about 1.55. The film structure 900 is affixed or otherwise adhered to the display surface 1004 of the display device 1002 by a compressive force applied to the film structure 900 and the display device 1002 that causes the adhesive material on the bottom surface 902 of the film structure 900 to bond to the display surface 1004 of the display device 1002.

In an exemplary embodiment, the display device 1002 is realized as a touchscreen or another touch-sensing device comprising a display 1006 and a transparent touch panel 1008. Depending on the embodiment, the display 1006 may be realized as a liquid crystal display (LCD), an light emitting diode (LED) display, an organic light emitting diode (OLED) display, an electrophoretic display, or another electronic display capable of presenting images under control of a processing module (e.g., a processor, controller, or the like). The touch panel 1008 is disposed proximate the display 1006 and aligned with respect to the display 1006 such that the touch panel 1008 is interposed in the line-of-sight when the user views content displayed on the display 1006. The touch panel 1008 provides or otherwise defines an active sensing region of the display device 1002, that is, a region of the display device 1002 that is capable of sensing contact and/or sufficient proximity to an external object (e.g., a finger and/or fingernail, a stylus, a pen, or the like). In this regard, the film structure 900 is disposed such that the film structure 900 overlaps and/or overlies the sensing region of the display device 1002. Depending on the embodiment, the touch panel 1008 may be realized as a resistive touch panel, a capacitive touch panel, an infrared touch panel, an optical touch panel, or another suitable touch panel. As described above, by virtue of the substantially vertical sidewalls and substantially horizontal upper surfaces for the surface structures 110, the scattering and/or diffusion of the light transmitted by the display 1006 that is incident on the film structure 900 orthogonal to the planar surface 103 is minimized or otherwise imperceptible.

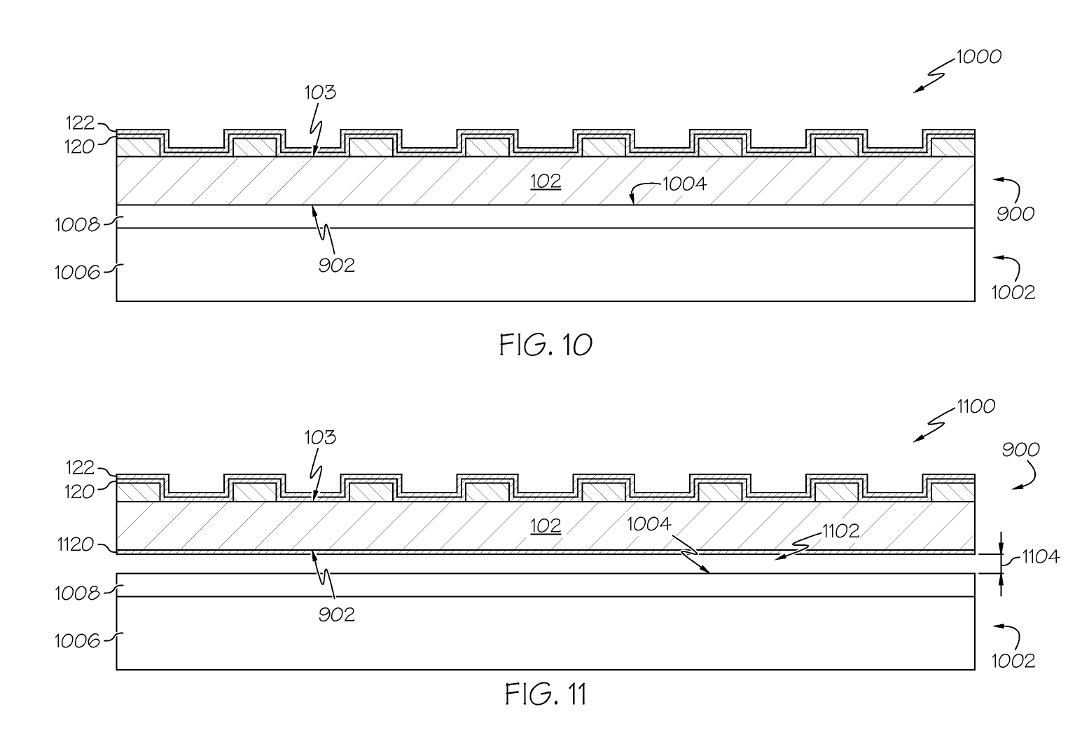

FIG. 11 illustrates another embodiment of a display system 1100 utilizing the film structure 900 with the display device 1002. The film structure 900 is disposed proximate the display device 1002 and aligned with respect to the display device 1002 such that the film structure 900 is interposed in the line-of-sight between a user and the display device 1002 when the user views content displayed on the display device 1002. In this regard, from the perspective of a user and/or viewer of the display device 1002, the film structure 900 overlaps and/or overlies at least a portion of the display device 1002. In the illustrated embodiment, the transparent substrate 102 is realized as a rigid glass material, wherein the bottom surface 902 of the transparent substrate 102 is separated from the display surface 1004 by an airgap 1102. In this regard, an adhesive material, such as an adhesive tape with an appropriate thickness, may be provided about the periphery of the display surface 1004 and/or film structure 900 to provide a bond between the film structure 900 and the display device 1002. The thickness of the adhesive material controls the separation distance 1104 between the film structure 900 and the display surface 1004. In one embodiment, the film structure 900 and the display device 1002 may be packaged using a bezel around the periphery of the film structure 900. The distance 1104 between the film structure 900 and the display surface 1004 (e.g., the width of the airgap 1102) is less than about four millimeters. In an exemplary embodiment, a second anti-reflective coating layer 1120 is formed on the bottom surface 902 of the film structure 900 in a similar manner as described above in the context of FIG. 8.

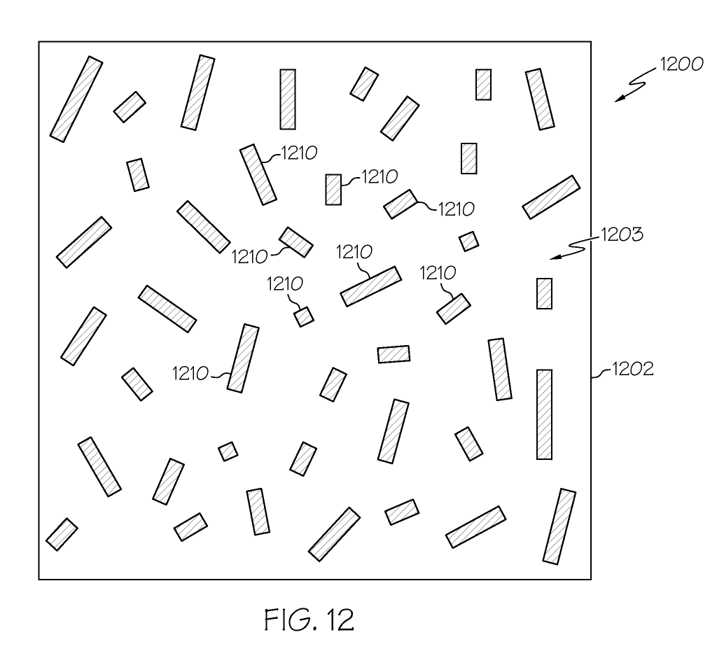

FIG. 12 illustrates a top view of an exemplary film structure 1200 comprising a plurality of surface structures 1210 formed on the surface 1203 of a transparent substrate 1202. Depending on the embodiment, the surface structures 1210 may be formed in accordance with the fabrication process described above in the context of FIGS. 1-4 or the fabrication process described above in the context of FIGS. 5-7. In the illustrated embodiment, the surface structures 1210 are randomly arranged on the surface 1203 of the substrate 1202 to provide a pattern configured to break up, redistribute, or otherwise inhibit formation of a continuous region of a contaminant (e.g., oils, sweat, and the like resulting from finger prints, dust, or other environmental contaminants) on the surface 1203 of the film structure 1200 and prevent creation of Moiré patterns, as described above. The height, width and/or separation distance between adjacent structures 1210 are preferably chosen to achieve a desired level of anti-smudge and anti-finger print performance by preventing a substantial portion of the surface 1203 from being touched by fingertips of a user under practical finger touching pressure conditions.

To briefly summarize, one advantage of the transparent film structure described above is that the transparent film structure utilizes inorganic anti-smudge surface structures to provide resistance to fingerprints, smudging, and other surface markings without noticeably degrading image quality. The inorganic surface structures provide relatively high durability, and thus, the film structure maintains resistance to fingerprints, smudges, scratches, and/or other marks over a longer duration of time. In addition to the durability provided by the inorganic surface structures, the inorganic material is also compatible with existing surface treatment methods (e.g., anti-reflective coatings and low surface energy coatings). As a result, the transparent film structure achieves relatively low surface reflection while also providing a cleanable and durable surface that is also resistant to fingerprints, smudges, and scratches.

For the sake of brevity, conventional techniques related to optics, reflection, refraction, anti-reflective coatings, low surface energy coatings, microstructures, deposition, etching, photolithography, touch-sensing devices and/or display devices may not be described in detail herein. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It being understood that various changes may be made in the function and arrangement of elements described in an exemplary embodiment without departing from the scope of the subject matter as set forth in the appended claims.

What is claimed is:

1. A method for forming a film structure, the method comprising:
providing a transparent substrate; and
forming a plurality of transparent surface structures overlying the transparent substrate, wherein each of the transparent surface structures comprises an inorganic material.

2. The method of claim 1, wherein forming the transparent surface structures comprises:
forming a layer of the inorganic material overlying the transparent substrate; and
selectively removing portions of the layer of the inorganic material, resulting in a plurality of surface structures comprising the inorganic material.

3. The method of claim 2, wherein selectively removing portions of the layer of the inorganic material comprises anisotropically etching the layer of the inorganic material.

4. The method of claim 2, wherein forming the layer of the inorganic material comprises depositing a layer of silicon dioxide overlying the transparent substrate.

5. The method of claim 4, wherein depositing the layer of silicon dioxide comprises depositing the layer of silicon dioxide by performing a plasma enhanced chemical vapor deposition (PECVD) process.

6. The method of claim 5, wherein depositing the layer of silicon dioxide comprises depositing the layer of silicon dioxide by performing the PECVD process utilizing silane and nitrous oxide as reactants, wherein a ratio of silane to nitrous oxide is such that a refractive index of the layer of silicon dioxide is equal to a refractive index of the transparent substrate.

7. The method of claim 1, wherein forming the transparent surface structures comprises:
forming a patterned layer of photoresist overlying the transparent substrate;
depositing a layer of the inorganic material overlying the patterned layer of photoresist; and
removing the patterned layer of photoresist.

8. The method of claim 7, wherein forming the patterned layer of photoresist comprises:
forming a layer of photoresist material; and
anisotropically etching the layer of photoresist material, resulting in the patterned layer of photoresist having one or more voided regions.

9. The method of claim 8, wherein depositing the layer of the inorganic material overlying the patterned layer of photoresist comprises partially filling the one or more voided regions.

10. A film structure comprising:
a transparent substrate; and
a plurality of transparent surface structures overlying the transparent substrate, wherein each transparent surface structure of the plurality of transparent surface structures comprises an inorganic material formed overlying the transparent substrate.

11. The film structure of claim 10, wherein the plurality of transparent surface structures are configured to inhibit formation of a continuous region of a contaminant on the transparent substrate.

12. The film structure of claim 10, wherein the inorganic material comprises silicon dioxide.

13. The film structure of claim 10, wherein the inorganic material comprises a non-polymeric chemical compound that does not include carbon.

14. The film structure of claim 13, wherein the inorganic material has a transparency greater than ninety percent for visible light and a pencil hardness greater than six.

15. The film structure of claim 10, wherein each surface structure comprises an anisotropically etched portion of the inorganic material having vertical sidewalls.

16. A display system comprising:
a display device having a display surface; and
a film structure overlying the display surface, the film structure comprising:
a transparent substrate; and
a plurality of surface structures, wherein each surface structure of the plurality of surface structures comprises a transparent inorganic material formed on a first surface of the transparent substrate.

17. The display system of claim 16, the display device having a sensing region, wherein the film structure overlies the sensing region.

18. The display system of claim 16, wherein the plurality of surface structures are configured to inhibit formation of a continuous region of a contaminant on the display surface.

19. The display system of claim 16, the transparent substrate having a second surface opposite the first surface, wherein the second surface is affixed to the display surface.

20. The display system of claim 16, the transparent substrate having a second surface opposite the first surface, wherein the second surface is separated from the display surface by an airgap.
